(19) United States
(12) Patent Application Publication
(10) Pub. No.: US 2023/0194306 A1
(43) Pub. Date: Jun. 22, 2023

(54) MULTI-SENSOR FUSION-BASED SLAM METHOD AND SYSTEM

(71) Applicant: Beijing GreenValley Technology Co., Ltd., Haidian District, Beijing (CN)

(72) Inventor: Jiting LIU, Beijing (CN)

(21) Appl. No.: 17/791,505

(22) PCT Filed: May 28, 2020
(86) PCT No.: PCT/CN2020/092921

§ 371 Date: Jul. 7, 2022

(30) Foreign Application Priority Data
May 19, 2020 (CN) 202010422626.7

(51) Int. Cl. G01C 21/00

(52) U.S. Cl. CPC G01C 21/3848; G01C 21/3837

(57) ABSTRACT

The present invention provides a multi-sensor fusion-based Simultaneous Localization And Mapping (SLAM) mapping method and system for a server, comprising: obtaining a plurality of sensor data regarding a surrounding environment of a moving platform, the plurality of sensor data including point cloud data, image data, inertial measurement unit (IMU) data, and global navigation satellite system (GNSS) data; performing hierarchical processing on the plurality of sensor data to generate a plurality of localization information, wherein one sensor data corresponds to one localization information; obtaining target localization information of the moving platform based on the plurality of localization information; generating a high-precision local map based on the target localization information; and performing a closed-loop detection operation to the high-precision local map to obtain a high-precision global map of the moving platform. The present invention mitigates the technical problem in the related art that easy susceptibility to a surrounding environment leads to low precision.

### TECHNICAL FIELD

The present invention relates to the field of navigational multi-sensor fusion technologies, and in particular, to a multi-sensor fusion-based Simultaneous Localization And Mapping (SLAM) method and system.

### BACKGROUND

SLAM technology is real-time localization and map construction. That is, data regarding a surrounding environment collected by sensors is processed, the current location of a moving system in an unknown environment is fed back in real time, and the map of the surrounding environment of the moving system is drawn simultaneously. This map may be a 2D planar map or a 3D map of the surrounding environment. The technology has been widely used in robotics, autonomous driving, virtual reality, mapping, agriculture, forestry, electric power, construction, among other industries. At present, common sensor units include a laser, an inertial measurement unit (IMU), a vision camera, and a global navigation satellite system (GNSS).

Currently, relatively mature SLAM algorithms may be broadly classified into laser SLAM and visual SLAM. In the laser SLAM, a laser sensor is mainly used to obtain data for simultaneous localization and mapping. A laser does not depend on the lighting of a surrounding environment and can scan the high-precision 3D information of the surrounding environment. The algorithm of the laser SLAM is relatively robust. At present, as the cost of lasers decreases, laser SLAM gradually becomes one of the popular research fields in the SLAM field. However, in an environment without obvious structures, for example, an environment such as a flat wall, grassland, or a narrow corridor, lasers cannot detect effective environmental features, and as a result localization and mapping tend to fail. In the visual SLAM, a camera sensor is mainly used to obtain image data of a surrounding environment, and captured image information is used to perform localization and mapping. The visual SLAM has a low price and strong visualization and has been the most popular orientation in the field of SLAM research. However, a visual camera is very dependent on the lighting information and texture information of the surrounding environment. Once the lighting changes excessively or the texture is repetitive and monotonous, the mapping tends to fail.

In both the laser SLAM and the visual SLAM, accumulated errors gradually increase with the elapse of time, resulting in reduced precision in localization and mapping. A closed-loop manner is a relatively popular at present used for correction. However, in large-scale mapping, limited by a surrounding environment, the precision often fails to meet the precision required in current map production.

### SUMMARY OF THE INVENTION

In view of this, an objective of the present invention is to provide a multi-sensor fusion-based SLAM mapping method and system, to mitigate the technical problem in the related art that easy susceptibility to a surrounding environment leads to low precision and great errors.

According to a first aspect, embodiments of the present invention provide a multi-sensor fusion-based SLAM mapping method for a server, comprising: obtaining a plurality of sensor data regarding a surrounding environment of a moving platform, the plurality of sensor data comprising point cloud data, image data, inertial measurement unit (IMU) data, and global navigation satellite system (GNSS) data; performing hierarchical processing on the plurality of sensor data to generate a plurality of localization information, wherein one sensor data corresponds to one localization information; obtaining target localization information of the moving platform based on the plurality of localization information; generating a high-precision local map based on the target localization information; and performing a closed-loop detection operation to the high-precision local map to obtain a high-precision global map of the moving platform.

Further, the step of obtaining the plurality of sensor data regarding the surrounding environment of the moving platform comprises: with a laser as a benchmark, calibrating position relationships among a camera, an IMU, a GNSS, and the laser to obtain calibration information, wherein the laser, the camera, the IMU, and the GNSS are all sensors on the moving platform; with time of the GNSS as a benchmark, synchronizing time of the laser, time of the camera, and time of the IMU to a current time system of the GNSS; and synchronously collecting data from the laser, the camera, the IMU, and the GNSS to obtain the plurality of sensor data regarding the surrounding environment of the moving platform, where the point cloud data is the data collected from the laser, the image data is the data collected from the camera, the IMU data is the data collected from the IMU, and the GNSS data is the data collected from the GNSS.

Further, in the step of performing hierarchical processing on the plurality of sensor data, a plurality of localization information is generated, which includes initial localization information, first localization information, and second localization information, comprising: generating the initial localization information based on the IMU data, the GNSS data, and the calibration information; generating the first localization information by using visual SLAM on basis of the initial localization information and the image data; and generating the second localization information by using laser SLAM on basis of the first localization information and the point cloud data.

Further, the step of obtaining target localization information of the moving platform based on the plurality of localization information comprises: extracting a keyframe matching point set of the image data and a point cloud data matching point set; generating a comprehensive localization information database based on the second localization information, the IMU data, the GNSS data, the keyframe matching point set, and the point cloud data matching point set; performing joint optimization to data sets in the comprehensive localization information database to gain a high-precision trace of the moving platform; and using the high-precision trace as the target localization information.

Further, in the step of generating a high-precision local map on the target localization information, the high-precision local map includes a local image map and a local point cloud three-dimensional scene map, comprising: resolving position and attitude information of the keyframe of the image data based on the high-precision trace to generate the local image map; and resolving position and attitude information of the point cloud data based on the high-precision trace to generate the local point cloud three-dimensional scene map.

Further, the step of performing a closed-loop detection operation to the high-precision local map to obtain a high-precision global map of the moving platform comprises: performing the closed-loop detection operation to the high-precision local map to obtain a local map rotation and translation matrix; constructing an image optimization pose constraint based on the local map rotation and translation matrix; correcting the high-precision trace by using the image optimization pose constraint to obtain a corrected high-precision trace; and obtaining the high-precision global map of the moving platform based on the corrected high-precision trace.

According to a second aspect, the embodiments of the present invention further provide a multi-sensor fusion-based SLAM mapping system for a server, comprising an obtaining module, a hierarchical processing module, a localizing module, a first generation module, and a second generation module, wherein the obtaining module is configured to obtain a plurality of sensor data regarding a surrounding environment of a moving platform, the plurality of sensor data comprising point cloud data, image data, inertial measurement unit (IMU) data, and global navigation satellite system (GNSS) data; the hierarchical processing module is configured to perform hierarchical processing on the plurality of sensor data to generate a plurality of localization information, wherein one sensor data corresponds to one localization information; the localizing module is configured to obtain target localization information of the moving platform based on the plurality of localization information; the first generation module is configured to generate a high-precision local map based on the target localization information; and the second generation module is configured to perform a closed-loop detection operation on the high-precision local map to obtain a high-precision global map of the moving platform.

Further, the obtaining module further comprises a calibration unit, a synchronization unit, and a collection unit, wherein the calibration unit is configured with a laser as a benchmark to calibrate position relationships among a camera, an IMU, a GNSS, and the laser to obtain calibration information, wherein the laser, the camera, the IMU and the GNSS are all sensors on the moving platform; the synchronization unit is configured with time of the GNSS as a benchmark to synchronize time of the laser, time of the camera, and time of the IMU to a current time system of the GNSS; and the collection unit is configured to synchronously collect data from the laser, the camera, the IMU, and the GNSS to obtain the plurality of sensor data regarding the surrounding environment of the moving platform, wherein the point cloud data is the data collected from the laser, the image data is the data collected from the camera, the IMU data is the data collected from the IMU, and the GNSS data is the data collected from the GNSS.

According to a third aspect, the embodiments of the present invention further provide an electronic device comprising a memory, a processor and a computer program stored in the memory and performed by the processor, wherein the processor, when performing the computer program, implements steps in the method according to the foregoing first aspect.

According to a fourth aspect, the embodiments of the present invention further provide a computer-readable medium having nonvolatile program code performed by a processor, wherein the processor performs the method according to the foregoing first aspect according to the program code.

The present invention provides a multi-sensor fusion-based SLAM mapping method and system for a server, comprising: obtaining a plurality of sensor data regarding a surrounding environment of a moving platform, the plurality of sensor data including point cloud data, image data, IMU data, and GNSS data; performing hierarchical processing on the plurality of sensor data to generate a plurality of localization information, wherein one sensor data corresponds to one localization information; obtaining target localization information of the moving platform based on the plurality of localization information; generating a high-precision local map based on the target localization information; and performing a closed-loop detection operation to the high-precision local map to obtain a high-precision global map of the moving platform. The present invention mitigates the technical problem in the related art that easy susceptibility to a surrounding environment leads to low precision and great errors.

### BRIEF DESCRIPTION OF THE DRAWINGS

To describe the technical solutions in specific embodiments of the present invention or the prior art more clearly, the following briefly introduces the accompanying drawings required for describing the specific embodiments or the prior art. Apparently, the accompanying drawings in the following description show some embodiments of the present invention, and a person of ordinary skill in the art may still derive other drawings from these accompanying drawings without creative efforts.

FIG. 1 is a flowchart of a multi-sensor fusion-based SLAM mapping method according to an embodiment of the present invention;

FIG. 2 is a method flowchart of obtaining a plurality of sensor data regarding a surrounding environment of a moving platform according to an embodiment of the present invention;

FIG. 3 is a method flowchart of performing hierarchical processing on a plurality of sensor data according to an embodiment the present invention;

FIG. 4 is a method flowchart of performing joint optimization on a plurality of localization information according to an embodiment the present invention;

FIG. 5 is a method flowchart of obtaining a high-precision global map of a moving platform according to an embodiment of the present invention;

FIG. 6 is a schematic diagram of a multi-sensor fusion-based SLAM mapping system according to an embodiment of the present invention; and

FIG. 7 is a schematic diagram of another multi-sensor fusion-based SLAM mapping system according to an embodiment of the present invention.

### DETAILED DESCRIPTION

The following clearly and completely describes the technical solutions of the present invention with reference to the accompanying drawings. Apparently, the described embodiments are merely some rather than all of the embodiments of the present invention. All other embodiments obtained by a person of ordinary skill in the art based on the embodiments of the present invention without creative efforts shall fall within the protection scope of the present invention.

### Embodiment 1

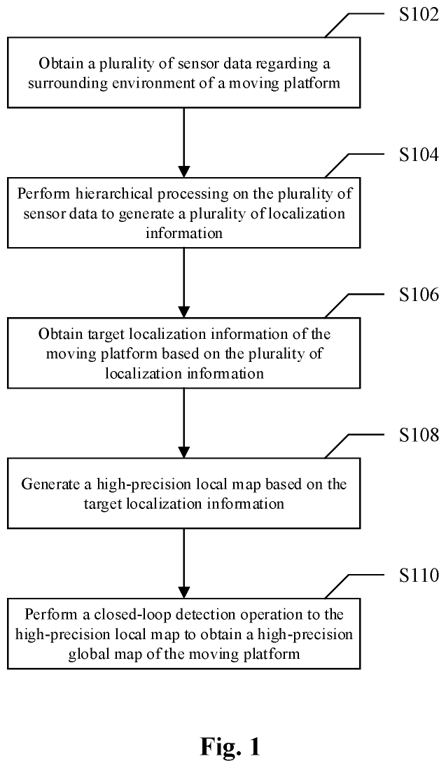

FIG. 1 is a flowchart of a multi-sensor fusion-based SLAM mapping method according to an embodiment of the present invention. The method is applied to a server. As shown in FIG. 1, the method specifically includes the following steps.

Step S102: Obtain a plurality of sensor data regarding a surrounding environment of a moving platform, the plurality of sensor data includes point cloud data, image data, IMU data, and GNSS data.

Specifically, a laser collects point cloud information of a surrounding environment to obtain the point cloud data. A camera collects image information to obtain the image data. An IMU obtains the angular velocity and acceleration of the moving platform to obtain the IMU data. A GNSS obtains the absolute longitude and latitude coordinates at every moment to obtain the GNSS data.

Step S104: Perform hierarchical processing on the plurality of sensor data to generate a plurality of localization information, wherein one sensor data corresponds to one localization information.

Step S106: Obtain target localization information of the moving platform based on the plurality of localization information.

Step S108: Generate a high-precision local map based on the target localization information.

Step S110: Perform a closed-loop detection operation to the high-precision local map to obtain a high-precision global map of the moving platform.

The present invention provides a multi-sensor fusion-based SLAM mapping method, including: obtaining a plurality of sensor data regarding a surrounding environment of a moving platform, the plurality of sensor data including point cloud data, image data, IMU data, and GNSS data; performing hierarchical processing on the plurality of sensor data to generate a plurality of localization information, wherein one sensor data corresponds to one localization information; obtaining target localization information of the moving platform based on the plurality of localization information; generating a high-precision local map based on the target localization information; and performing a closed-loop detection operation to the high-precision local map to obtain a high-precision global map of the moving platform. The present invention mitigates the technical problem in the related art that easy susceptibility to a surrounding environment leads to low precision and great errors.

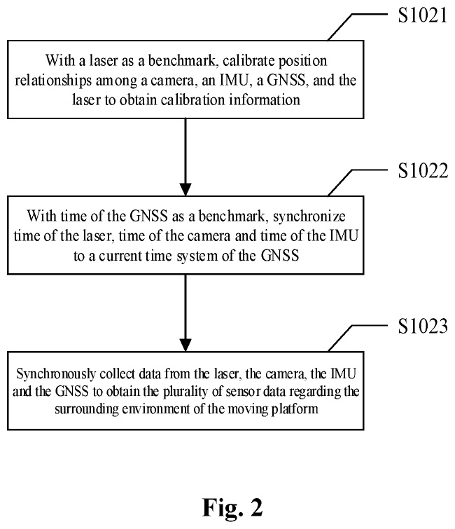

Optionally, as shown in FIG. 2, Step S102 includes the following steps.

Step S1021: With a laser as a benchmark, calibrate position relationships among a camera, an IMU, a GNSS, and the laser to obtain calibration information, where the laser, the camera, the IMU, and the GNSS are all sensors on the moving platform.

Specifically, for the calibration between the laser and the camera, a laser and a camera on the same rigid body are used to face a calibration target to collect data. Information such as surface features in point cloud data and corner points in an image are fitted. Optimization is performed by using a distance from a point to a surface to solve extrinsic parameters of the camera and the laser. For the calibration between the laser and the IMU, the trace of a moving device may be obtained by using the point cloud data collected by the laser, and the trace of the moving device may also be obtained by the IMU. Extrinsic parameters may be obtained by aligning the traces. Because an accelerometer of the IMU is prone to drift, the extrinsic parameters between the two can only be approximately estimated (or measured with a ruler).

Step S1022: With time of the GNSS as a benchmark, synchronize time of the laser, time of the camera and time of the IMU to a current time system of the GNSS.

Step S1023: Synchronously collect data from the laser, the camera, the IMU and the GNSS to obtain the plurality of sensor data regarding the surrounding environment of the moving platform, wherein the point cloud data is the data collected from the laser, the image data is the data collected from the camera, the IMU data is the data collected from the IMU, and the GNSS data is the data collected from the GNSS.

In the embodiments of the present invention, the plurality of localization information include initial localization information, first localization information, and second localization information.

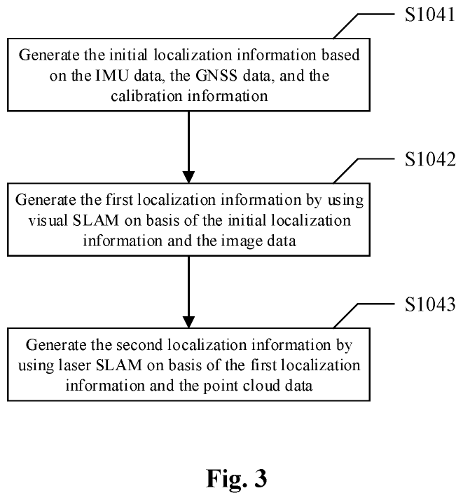

Optionally, as shown in FIG. 3, Step S104 includes the following steps.

Step S1041: Generate the initial localization information based on the IMU data, the GNSS data, and the calibration information.

Specifically, the initialization and alignment of a navigation system are first completed on the moving platform. Initial parameters of Kalman filtering are set, and then a posteriori state estimation information P0ₜ at every moment t is solved by using GNSS global localization information, an INS, and the Kalman filtering theory.

Step S1042: Generate the first localization information by using visual SLAM on basis of the initial localization information and the image data.

Specifically: a) For each keyframe image, feature points of the keyframe image are calculated. Specific feature points include an ORB feature point, a Harris corner point, and the like.

b). For two adjacent image keyframes, according to initial localization information P0, feature points F₁ and F₂ with positions corrected are shown in the following formula. P^{t-1} represents a set of all feature points of the image frame F₁, and P^{t} represents a set of all feature points of the image frame F₂.

$$\{ \begin{matrix}{P}^{t} = \{ {P}_{1}^{t} , {P}_{1}^{t} , … , {P}_{N}^{t} \} ∈ {F}_{1} \\ {P}^{t - 1} = \{ {P}_{1}^{t - 1} , {P}_{1}^{t - 1} , … , {P}_{1}^{t - 1} \} ∈ {F}_{2}\end{matrix} .$$

RANSAC is used to eliminate outliers, and the calculation is further optimized to obtain feature points P^{t} and P^{t-1} in a normalization plane of the camera.

For the reason of being in the same feature environment, a conversion relationship among these feature matching point pairs may be expressed as the following formula: ∀i, Pᵢ^{t}=RPᵢ^{t-1}+T, wherein R is a pose rotation and transformation matrix of a robot, T is a displacement matrix of the robot, and Pᵢ^{t} and Pᵢ^{t-1} are a feature point matching point pair from a moment t to a moment t+1. A method of minimizing a reprojection error is used to solve poses R and T, as shown in the following formula:

{R,T}=arg min Σᵢ₌₁^{N}∥Pᵢ^{t}−(R^{t-1}Pᵢ+T)∥², wherein P^{t} represents the set of all feature points of the image frame F₁, and P^{t-1} represents the set of all feature points of the image frame F₁; and R is a rotation matrix of a vector, T is a translation vector of the vector, and N represents a quantity of feature point pairs.

A rotation and translation matrix of adjacent keyframes is calculated, first localization information P1 of all keyframes is sequentially obtained, and a current optimal feature matching pair (that is, an optimal feature matching pair regarding the first localization information P1) is added to a matching database.

Step S1043: Generate the second localization information by using laser SLAM on basis of the first localization information and the point cloud data.

Specifically, for laser point cloud data P_{K} of a current frame, according to the following formula, a point feature F_{K1}, a line feature F_{K2}, and a surface feature F_{K3} of the laser point cloud data may be calculated.

$$f = \frac{1}{\vert p \vert \cdot ‖ {X}_{i} ‖} {\sum }_{j ∈ p , j \neq i} ‖ ( {X}_{i} - {X}_{j} ) ‖ ,$$

wherein i is a point in P_{K}, Xᵢ is a coordinate of the point i, p is a neighborhood point set of the point i, j is a point in p, Xᵢ is a coordinate of the point i, and f is a feature value; and thresholds M₁, M₂, M₃, and M₄ are given in advance, a point with the feature value f less than M₁ belongs to a feature Fₖ₁, a point with the feature value f greater than M₂ and less than M₃ belongs to Fₖ₂, and a point with the feature value f greater than M₄ belongs to Fₖ₃.

According to the first localization information P1, feature data of each frame is converted into a coordinate system corresponding to the localization information P1. Point cloud data Pₜ and Pₜ₋₁ of two adjacent frames are obtained, domain search is performed in Fₜ to all matching pairs Fₜ₋₁, to determine all candidate feature matching pairs. Rotation and translation parameters R and T of the point cloud data of the two adjacent frames are solved according to the matching pairs and by using a least squares method. Specifically, the parameters may be solved by using the following formula:

Y=RX+T, wherein Y represents a feature extracted from the latter data frame of the two adjacent data frames, X represents a feature extracted from the former data frame of the two adjacent data frames, R is a rotation matrix of a vector, and T is a translation vector of the vector.

Next, selection may be performed to matching pairs according to an obtained result, and the feature point Fₜ′ is calculated again. For a feature point in a point cloud Pₜ₋₁, Fₜ is searched again for feature point pairs, and recalculation is performed to obtain new rotation and translation matrices R and T, which are updated. Finally, rotation and translation position information Rₜ₋₁ and Tₜ₋₁ of two adjacent frames are finally obtained, and a current optimal feature matching pair is added to a matching database K.

Finally, according to a conversion matrix of adjacent frames, second localization information P2 according to laser point cloud data is obtained (that is, an optimal feature matching pair of the second localization information P2). The foregoing FIG. 3 involves the following operations: Step S1041: Generate the initial localization information based on the IMU data, the GNSS data, and the calibration information. Step S1042: Generate the first localization information by using visual SLAM on basis of the initial localization information and the image data. Step S1043: Generate the second localization information by using laser SLAM on basis of the first localization information and the point cloud data. In the foregoing technical solution, a brand new algorithm design is used for generating the initial localization information based on the IMU data, the GNSS data, and the calibration information (a method of minimizing a reprojection error and a least squares method are combined). The foregoing calculation algorithm is applied to obtain initial localization information.

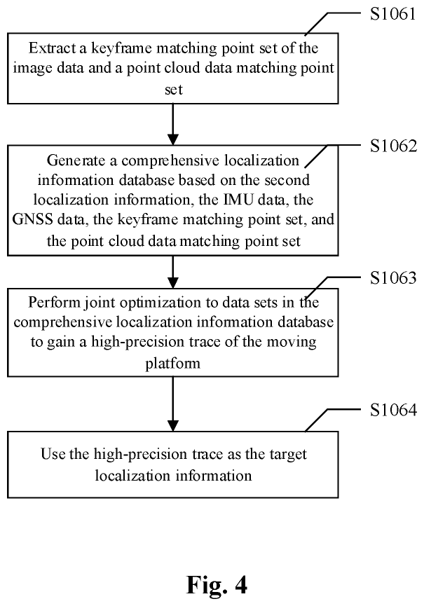

Optionally, FIG. 4 is a method flowchart of performing joint optimization on a plurality of localization information according to an embodiment the present invention. As shown in FIG. 4, the method includes the following steps:

Step S1061: Extract a keyframe matching point set of the image data and a point cloud data matching point set.

Step S1062: Generate a comprehensive localization information database based on the second localization information, the IMU data, the GNSS data, the keyframe matching point set, and the point cloud data matching point set.

Step S1063: Perform joint optimization to data sets in the comprehensive localization information database to gain a high-precision trace of the moving platform.

Step S1064: Use the high-precision trace as the target localization information.

Specifically, a sliding window with a capacity of n is first constructed. Each unit of the sliding window includes keyframe matching pair information of an original camera or laser point cloud matching pair information, and IMU preintegration information. The IMU preintegration information is an observed value formed by all IMU data of two consecutive frames of data through an IMU preintegration model. Next, a factor graph model is sequentially constructed for data in the sliding window, including constructing an IMU preintegration constraint Z^{imu}, a laser point cloud feature matching constraint Z^{laser}, an image keyframe matching constraint Z^{img}, a GNSS position constraint Z^{gnss}, and the like. A maximum a posteriori probability of joint probability distribution is solved, to obtain each state variable at each time point. A state vector that needs to be estimated is:

S={E,N,U,Vₑ,Vₙ,Vᵤ,roll,pitch,yaw,ϕₓ,ϕ_{y},ϕ_{z},σₓ,σ_{y},σ_{z}}.

Wherein E, N, and U respectively represent three-dimensional coordinates of a world coordinate system; Vₑ, Vₙ, and Vᵤ respectively represent an east velocity, a north velocity, and an up velocity; roll, pitch, and yaw represent attitude angles; ϕₓ, ϕ_{y}, and ϕ_{z} respectively represent deviation amounts of a gyroscope; and σₓ, σ_{y}, and σ_{z} respectively represent deviation amounts of an accelerometer.

For a state set Sₖ={S₁,δ₂, . . . ,Sₖ} at each moment, according to the foregoing constructed measured value set Z={Z^{imu},Z^{laser},Z^{img},Z^{gnss}}, a maximum a posteriori probability of joint probability distribution p(Sₖ|Zₖ) is solved: Sₖ′=argₓ_{ₖ}max p(Sₖ|Zₖ), wherein Sₖ′={S₁′,S₂′, . . . ,Sₖ′} represents an optimal estimated value of Sₖ. An optimal state amount is solved, to gain a high-precision trace T.

In the embodiments of the present invention, the high-precision local map includes a local image map and a local point cloud three-dimensional scene map. Optionally, step S108 further includes the following steps:

Step S1081: Resolve position and attitude information of the keyframe of the image data based on the high-precision trace to generate the local image map.

Step S1082: Resolve position and attitude information of the point cloud data based on the high-precision trace to generate the local point cloud three-dimensional scene map.

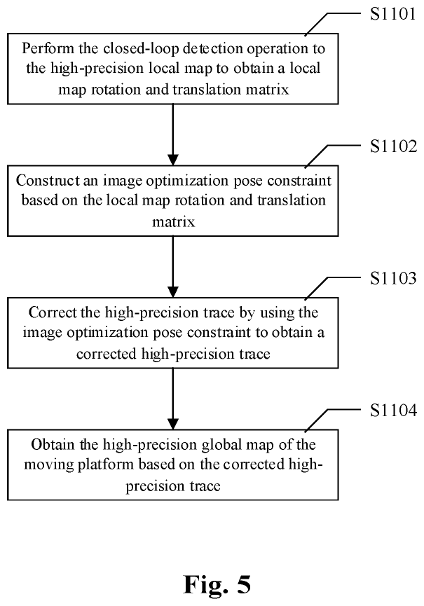

Optionally, as shown in FIG. 5, Step S110 includes the following steps.

Step S1101: Perform the closed-loop detection operation to the high-precision local map to obtain a local map rotation and translation matrix.

Specifically, it is initially determined according to the GNSS data whether there is a repetition between a current map and a previously scanned map. If a difference in longitude and latitude information is within a particular threshold, it is considered that the moving platform remains at the same position, and the two frames form a closed loop.

Next, it is determined, according to feature point information of images, whether there is a repetition between a local map of a current image and a previously formed image map, to perform closed-loop image detection. Specifically, a feature of each frame of picture is used to perform a search in a dictionary to calculate a similarity. If the similarity is excessively high, it is considered that the moving platform returns to a previous position, to form a closed loop.

Next, it is determined, according to laser point cloud information, whether there is a repetition between a current local point cloud map and a previously formed point cloud map, to determine to perform point cloud closed-loop detection.

Specifically, for obtained candidate determination point clouds i and j of two frames, a registration error E of the point clouds is calculated, and a minimum error function ϕ is calculated. The following formulas are function formulas for calculating a registration error and a minimum error.

E_{i,j}=Xi−T_{i,j}·Xⱼ,

ϕ=Σ_{i,j}∥Eᵢⱼ∥₂², wherein i is a point in a to-be-registered data frame in the current map, Xᵢ is coordinates of i, j is a point in a global coordinate system data frame, Xⱼ is coordinates of j, T_{i,j} is a rotation and translation matrix from j to i, E_{i,j} is the registration error, and ϕ is a preset norm.

A determination reference is a point cloud-based Intersection over Union (IoU), that is, a ratio of points with the same name in the point cloud to points in a point cloud overlap area when the registration error is minimal. If the IoU of a point cloud is greater than a particular percentage, it is determined that the point cloud is a closed loop. In this case, T_{i,j} is a rotation and translation matrix of the point cloud.

Step S1102: Construct an image optimization pose constraint based on the local map rotation and translation matrix.

Step S1103: Correct the high-precision trace by using the image optimization pose constraint to obtain a corrected high-precision trace.

Step S1104: Obtain the high-precision global map of the moving platform based on the corrected high-precision trace.

In the embodiments of the present invention, with the elapse of time, accumulated errors keep increasing, leading to reduced precision. Closed-loop detection may determine whether there is a great similarity between a scenario collected from a current frame and that from a previous frame. If yes, a loop is formed. The accumulation of errors may be reduced during optimization, to generate a high-precision global map.

Compared with the manner in the prior art, the embodiments of the present invention have at least one of the following advantages:

(1) A case that a single sensor fails in SLAM in a feature environment is resolved. The collection processing of the system has high stability and robustness.
(2) Multi-sensor fusion is used to resolve the problem that accumulated errors are large in a conventional SLAM algorithm, thereby improving the mapping precision of a global map.

### Embodiment 2

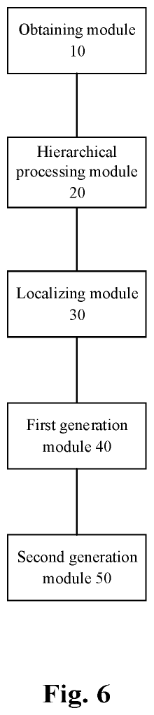

FIG. 6 is a schematic diagram of a multi-sensor fusion-based SLAM mapping system according to an embodiment of the present invention. The system is applied to a server. As shown in FIG. 6, the system includes an obtaining module 10, a hierarchical processing module 20, a localizing module 30, a first generation module 40, and a second generation module 50.

Specifically, the obtaining module 10 is configured to obtain a plurality of sensor data regarding a surrounding environment of a moving platform, the plurality of sensor data including point cloud data, image data, IMU data, and GNSS data.

The hierarchical processing module 20 is configured to perform hierarchical processing on the plurality of sensor data to generate a plurality of localization information, wherein one sensor data corresponds to one localization information.

The localizing module 30 is configured to obtain target localization information of the moving platform based on the plurality of localization information.

The first generation module 40 is configured to generate a high-precision local map based on the target localization information.

The second generation module 50 is configured to perform a closed-loop detection operation on the high-precision local map to obtain a high-precision global map of the moving platform.

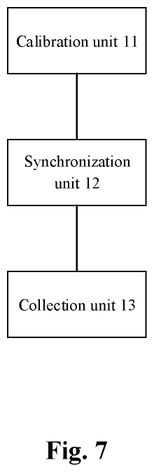

Optionally, FIG. 7 is a schematic diagram of another multi-sensor fusion-based SLAM mapping system according to an embodiment of the present invention. As shown in FIG. 7, the obtaining module 10 includes a calibration unit 11, a synchronization unit 12, and a collection unit 13.

Specifically, the calibration unit 11 is configured with a laser as a benchmark to calibrate position relationships among a camera, an IMU, a GNSS, and the laser to obtain calibration information, wherein the laser, the camera, the IMU and the GNSS are all sensors on the moving platform.

The synchronization unit 12 is configured with time of the GNSS as a benchmark to synchronize time of the laser, time of the camera, and time of the IMU to a current time system of the GNSS.

The collection unit 13 is configured to synchronously collect data from the laser, the camera, the IMU, and the GNSS to obtain the plurality of sensor data regarding the surrounding environment of the moving platform, wherein the point cloud data is the data collected from the laser, the image data is the data collected from the camera, the IMU data is the data collected from the IMU, and the GNSS data is the data collected from the GNSS.

The embodiments of the present invention further provide an electronic device including a memory, a processor and a computer program stored in the memory and performed by the processor, the processor, when performing the computer program, implements steps in the method according to Embodiment 1.

The embodiments of the present invention further provide a computer-readable medium having nonvolatile program code performed by a processor, the processor performs the method according to Embodiment 1 according to the program code.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some or all the technical features thereof, without departing from the scope of the technical solutions of the embodiments of the present invention.

1. A multi-sensor fusion-based Simultaneous Localization and Mapping (SLAM) method for a server, comprising:
obtaining a plurality of sensor data regarding a surrounding environment of a moving platform, the plurality of sensor data comprising point cloud data, image data, inertial measurement unit (IMU) data, and global navigation satellite system (GNSS) data;
performing hierarchical processing on the plurality of sensor data to generate a plurality of localization information, wherein one sensor data corresponds to one localization information;
obtaining target localization information of the moving platform based on the plurality of localization information;
generating a high-precision local map based on the target localization information; and
performing a closed-loop detection operation to the high-precision local map to obtain a high-precision global map of the moving platform.

2. The method according to claim 1, wherein the step of obtaining the plurality of sensor data regarding the surrounding environment of the moving platform comprises:
with a laser as a benchmark, calibrating position relationships among a camera, an IMU, a GNSS and the laser to obtain calibration information, wherein the laser, the camera, the IMU, and the GNSS are all sensors on the moving platform;
with time of the GNSS as a benchmark, synchronizing time of the laser, time of the camera, and time of the IMU to a current time system of the GNSS; and
synchronously collecting data from the laser, the camera, the IMU and the GNSS to obtain the plurality of sensor data regarding the surrounding environment of the moving platform, wherein the point cloud data is the data collected from the laser, the image data is the data collected from the camera, the IMU data is the data collected from the IMU, and the GNSS data is the data collected from the GNSS.

3. The method according to claim 2, wherein in the step of performing hierarchical processing on the plurality of sensor data, a plurality of localization information is generated, which includes initial localization information, first localization information, and second localization information, comprising:
generating the initial localization information based on the IMU data, the GNSS data, and the calibration information;
generating the first localization information by using visual SLAM on basis of the initial localization information and the image data; and
generating the second localization information by using laser SLAM on basis of the first localization information and the point cloud data.

4. The method according to claim 3, wherein the step of obtaining target localization information of the moving platform based on the plurality of localization information comprises:
extracting a keyframe matching point set of the image data and a point cloud data matching point set;
generating a comprehensive localization information database based on the second localization information, the IMU data, the GNSS data, the keyframe matching point set, and the point cloud data matching point set;
performing joint optimization to data sets in the comprehensive localization information database to gain a high-precision trace of the moving platform; and
using the high-precision trace as the target localization information.

5. The method according to claim 4, wherein in the step of generating a high-precision local map based on the target localization information, the high-precision local map includes a local image map and a local point cloud three-dimensional scene map, comprising:
resolving position and attitude information of the keyframe of the image data based on the high-precision trace to generate the local image map; and
resolving position and attitude information of the point cloud data based on the high-precision trace to generate the local point cloud three-dimensional scene map.

6. The method according to claim 5, wherein the step of performing a closed-loop detection operation to the high-precision local map to obtain a high-precision global map of the moving platform comprises:
performing the closed-loop detection operation to the high-precision local map to obtain a local map rotation and translation matrix;
constructing an image optimization pose constraint based on the local map rotation and translation matrix;
correcting the high-precision trace by using the image optimization posture constraint to obtain a corrected high-precision trace; and
obtaining the high-precision global map of the moving platform based on the corrected high-precision trace.

7. A multi-sensor fusion-based SLAM mapping system for a server, comprising an obtaining module, a hierarchical processing module, a localizing module, a first generation module, and a second generation module, wherein,
the obtaining module is configured to obtain a plurality of sensor data regarding a surrounding environment of a moving platform, the plurality of sensor data comprising point cloud data, image data, inertial measurement unit (IMU) data, and global navigation satellite system (GNSS) data;
the hierarchical processing module is configured to perform hierarchical processing on the plurality of sensor data to generate a plurality of localization information, wherein one sensor data corresponds to one localization information;
the localizing module is configured to obtain target localization information of the moving platform based on the plurality of localization information;
the first generation module is configured to generate a high-precision local map based on the target localization information; and
the second generation module is configured to perform a closed-loop detection operation on the high-precision local map to obtain a high-precision global map of the moving platform.

8. The system according to claim 7, wherein the obtaining module further comprises a calibration unit, a synchronization unit, and a collection unit, wherein,
the calibration unit is configured with a laser as a benchmark to calibrate position relationships among a camera, an IMU, a GNSS, and the laser to obtain calibration information, wherein the laser, the camera, the IMU and the GNSS are all sensors on the moving platform;
the synchronization unit is configured with time of the GNSS as a benchmark to synchronize time of the laser, time of the camera, and time of the IMU to a current time system of the GNSS; and
the collection unit is configured to synchronously collect data from the laser, the camera, the IMU, and the GNSS to obtain the plurality of sensor data regarding the surrounding environment of the moving platform, wherein the point cloud data is the data collected from the laser, the image data is the data collected from the camera, the IMU data is the data collected from the IMU, and the GNSS data is the data collected from the GNSS.

9. An electronic device comprising a memory, a processor and a computer program stored in the memory and performed by the processor, wherein the processor, when performing the computer program, implements steps in the method according to any one of claims 1 to 6.

10. A computer-readable medium having nonvolatile program code performed by a processor, wherein the processor performs the method according to any one of claims 1 to 6 according to the program code.
